(19) United States
(12) Patent Application Publication
(10) Pub. No.: US 2018/0372109 A1
(43) Pub. Date: Dec. 27, 2018

(54) Method and System of Obtaining a Bid For Services

(71) Applicant: Teligistics, Inc., Montgomery, TX (US)

(72) Inventor: David T. Roberts, Conroe, TX (US)

(73) Assignee: Teligistics, Inc., Montgomery, TX (US)

(21) Appl. No.: 16/121,176

(22) Filed: Sep. 4, 2018

Related U.S. Application Data
(63) Continuation-in-part of application No. 15/261,622, filed on Sep. 9, 2016.
Application No. 15/261,622 is a division of application No. 13/265,735, filed on Dec. 14, 2011, now Pat. No. 9,103,349.

(51) Int. Cl. F04D 25/08; F04D 25/06; H02K 7/14; H02K 5/24; H02K 5/18; H02K 5/10; H02K 5/22; F04D 29/66; H02K 11/33; H02K 5/20; H02K 5/04

(52) U.S. Cl. CPC F04D 25/08; F04D 25/068; H02K 7/14; H02K 5/24; H02K 5/18; H02K 5/10; H02K 5/04; F04D 29/668; H02K 11/33; F04D 25/0613; H02K 5/20; H02K 5/22

(57) ABSTRACT

A method and system of obtaining a bid from a provider of services, involving creating a client request for proposal (RFP) document, storing client RFP document in a data store, inviting a bidding service provider to respond a stored client RFP document, allowing an invited bidding service provider to access the stored client RFP document, allowing the bidding service provider to respond to the stored client RFP document, obtaining all completed responses and all rate elements from bidding service providers, generating a comparative financial analysis showing a sorted list of responses, generating a weighted report, the generated weighted report comprising a display of bids having a best compliance with client RFP document in top down order based on the comparative financial analysis, and providing the generated weighted report to the client.

### RELATIONSHIP TO OTHER APPLICATIONS

This application is a continuation-in-part of pending U.S. patent application Ser. No. 15/263,622, filed Sep. 13, 2016, now abandoned, which is a divisional of pending U.S. patent application Ser. No. 13/865,735, filed Apr. 18, 2013, now abandoned.

### BACKGROUND

Coordinating a request for proposal (“RFP”) to provide a service to a consumer of services, and coordinating responses to the RFP from a number of service providers, can be complicated and time consuming. Typically, the RFP process involves obtaining a response from each bidding service provider, such as but not limited to a telecommunications carrier, as to if and/or how they will comply with the requirements outlined in the RFP document. It can be helpful to have these responses generated as part of an auction or reverse auction process to arrive at the most competitive bid.

Problems arise when a request for services attempts to solicit bids but the requesting party cannot adequately compare responses because service providers either cannot provide all requested services and/or include “hidden” charges such as non-mandated surcharges in their responses. It also sometimes occurs that bids are accepted which do not reflect true responses for all intended services.

### DRAWINGS

The figures supplied herein disclose various embodiments of the claimed development.

FIG. 1 is a schematic illustration of an exemplary system;

FIG. 2 is an exemplary form illustrating aspects of a client RFP document;

FIG. 3 is an exemplary form illustrating aspects of client creation;

FIG. 4 is an exemplary form illustrating aspects of client creation;

FIG. 5 is an exemplary form illustrating further aspects of client RFP document creation and modification;

FIG. 6 is an exemplary form illustrating how a client RFP document is approved;

FIG. 7 is an exemplary form illustrating an invitation to a carrier to bid on an RFP;

FIG. 8 is an exemplary form illustrating a listing of those carriers invited to bid on an RFP;

FIG. 9 and FIG. 10 are exemplary forms illustrating aspects of carrier response forms;

FIG. 11 is an exemplary form illustrating further aspects of client 2 RFP document;

FIG. 12 is an exemplary form illustrating further aspects of carrier bid processes

FIG. 13 is an exemplary form illustrating a detail of a weighted report; and

FIG. 14 is a schematic view of a set of templates and a spreadsheet file.

### DETAILED DESCRIPTION OF EXEMPLARY EMBODIMENTS

In the system described herein, requests for bids and responses to such requests are typically displayed dynamically and the system allows updating of bids and of bids in real-time. The system and its computer-implemented methods are not simply the generalized use of a computer as a tool to conduct a known or obvious process, but, instead are improvements to the capability of a request for proposal system as a whole that allow a requesting party to compare responses where service providers provide all requested services where such comparisons include analyses of “hidden” charges such as non-mandated surcharges in their responses. This allows a requesting party to view and accept bids which reflect true responses for all intended services.

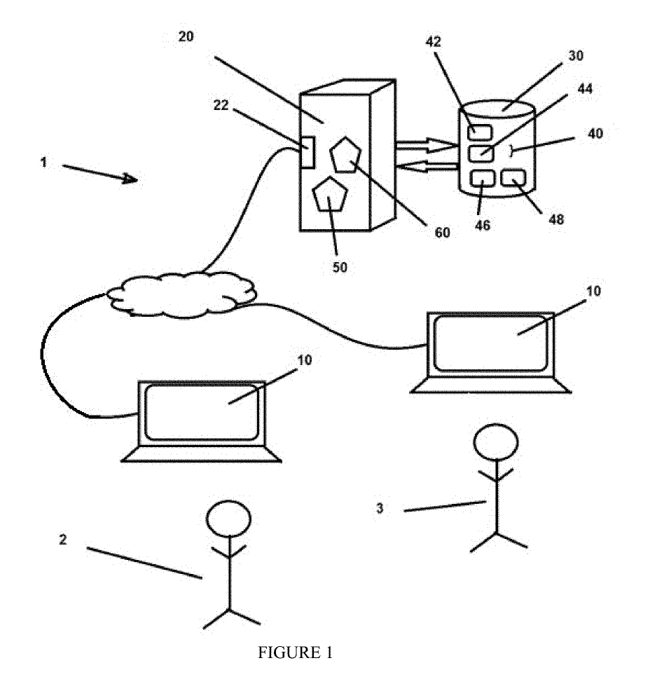

Referring now to FIG. 1, system 1 for processing a bid from a provider of services comprises web portal 10; computer 20 operatively in communication with web portal 10; data store 30 operatively in communication with computer 20; database 40 disposed on data store 30; database management software 50 operatively resident in computer 20, the database management software operative to manage database 40; and bid proposal software 60 operatively resident in computer 20, operatively accessible to user 2 and service provider 3 via web portal 10, and operatively in communication with database management software 50.

Web portal 10 is operatively, and in certain embodiments securely, accessible via a data network such as the Internet, typically via network interface 22 which is further accessible to computer 20. In a first embodiment, web portal 10 further comprises an ASP.NET component; a C# code behind component operatively in communication with the ASP.NET component; and an SQL database interface component, such as a Microsoft SQL Server database interface component, operatively in communication with the ASP.NET component or the C# code behind component, as these terms are familiar to those of ordinary skill in the programming arts. In a preferred embodiment, a predetermined number of data objects are also provided which comprise an AJAX component configured to communicate between client software processes and server software processes and a dual application programming interface (API) configured to be called from either a client or a server software process.

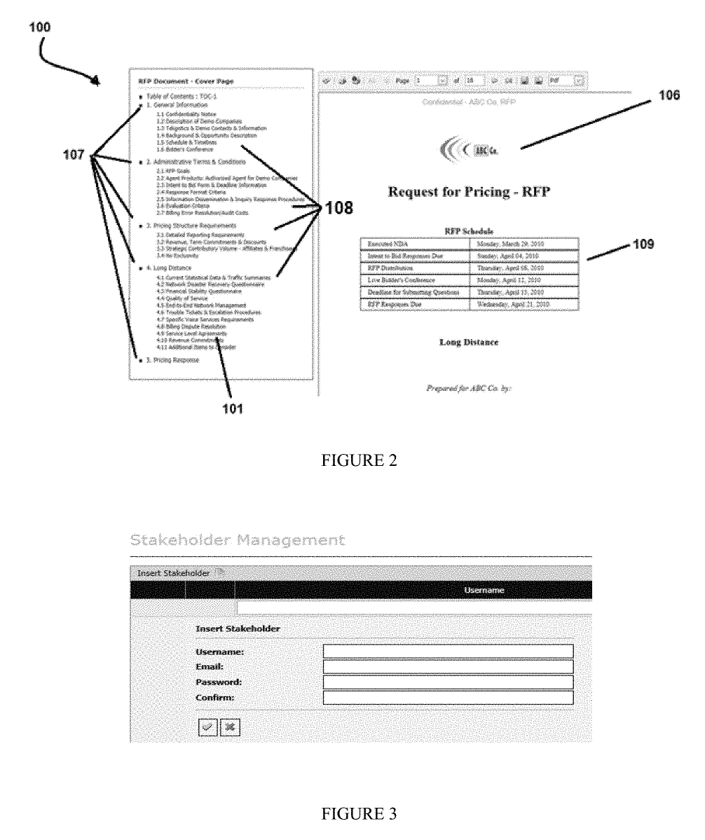

Database 40 typically comprises service provider table 42 comprising service provider data associated with service provider 3; request for proposal table 44 comprising request for proposal data associated with client 2; bid table 46 comprising service provider bid data associated with service provider 3, client 2, and a specific RFP, e.g. client RFP document 100 (FIG. 2); and request for proposal table 48 comprising RFP data such as may be reflected in client RFP document 100. These data are typically associated with, and/or obtained via, client RFP document 100 (FIG. 2).

Referring additionally now to FIG. 2, in typical embodiments client RFP document 100 comprises service description section 101, describing one or more services, such as but not limited to telecommunication (“telecom”) related services, that client 2 wishes to obtain from service provider 3; a set of specific requirements 102 (e.g., FIG. 10) associated with each service; textual description 103 of the service (e.g., FIG. 10); a predetermined set of individual rate elements 104 (not shown in the figures) of the service; and a predetermined set of associated current costs 105 (not shown in the figures) associated with the service. In further embodiments, client RFP document 100 may comprise a user or programmatically customizable client logo cover page 106; one or more document sections 107 (e.g., FIGS. 2 and 10) linked to client RFP document 100; one or more document subsections 108 (e.g., FIGS. 2 and 10) associated with document section 106; timeline 109, comprising an outline of a timeframe of all RFP items within a process for responding to client RFP document 100, where timeline 109 is linked to document section 106; and an image comprising a link to either document section 106 or document subsection 107. The image, if present, may be embedded during the generation of client RFP document 100 in a printable or exportable form of client RFP document 100.

Referring back to FIG. 1, bid proposal software 60 typically comprises template software 62 (not shown in the figures), bid software 64 (not shown in the figures), analysis software 66 (not shown in the figures), and response software 68 (not shown in the figures), each tailored to provide templates, bidding features, analysis features, and response features respectively, as further described below.

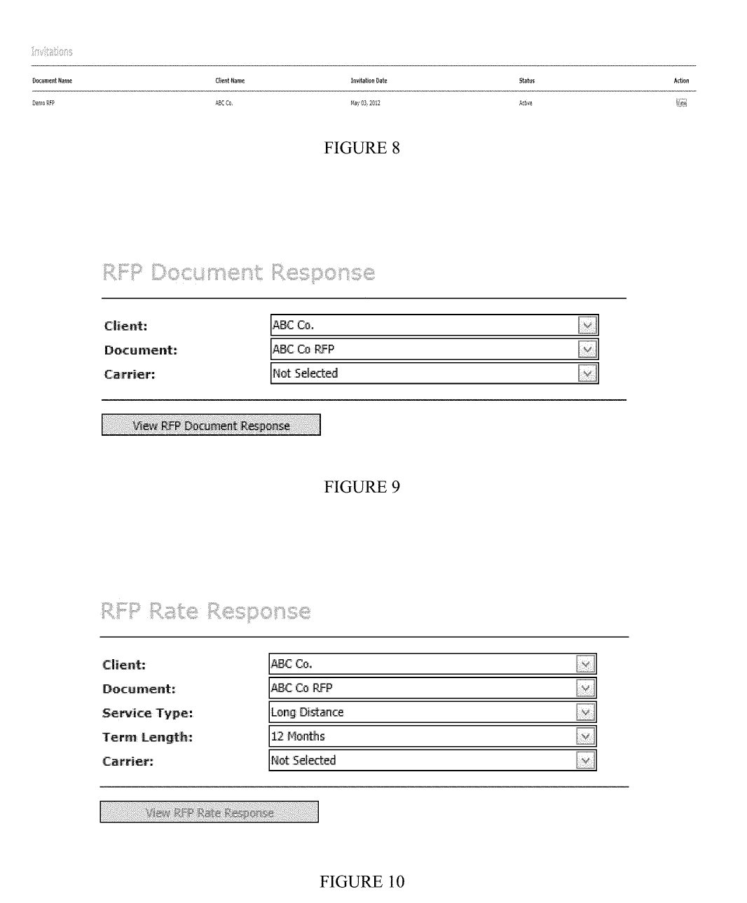

Template software 62 is typically configured to present a request for proposal form to client 2, obtain a desired set of services selected by client 2 using a request for proposal form such as illustrated in FIG. 8, and uniquely associate the selected desired set of services with client 2 in a unique record of request for proposal table 44.

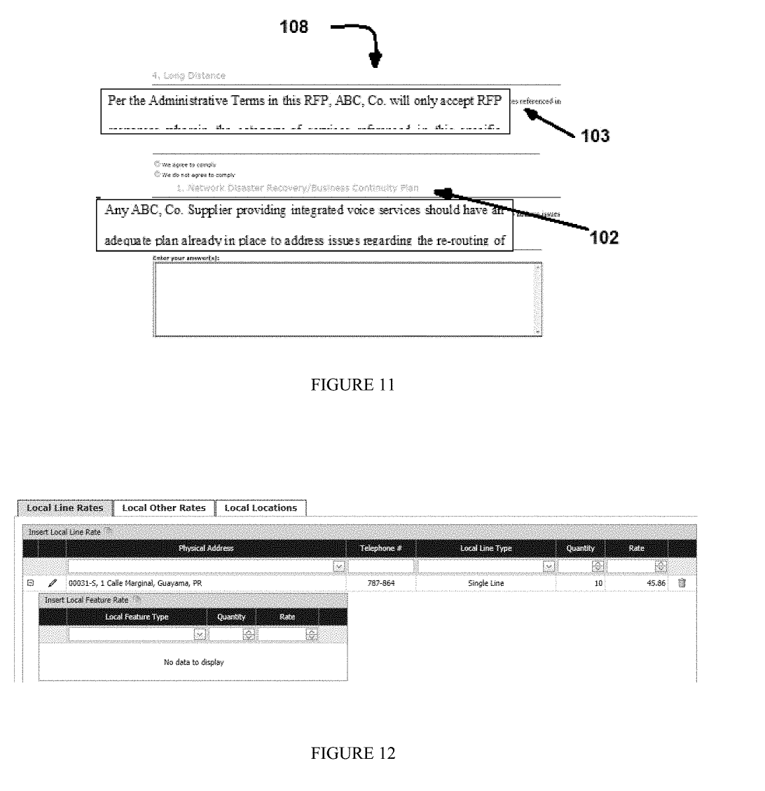

Bid software 64 is typically configured to present a bid form, such as illustrated in FIG. 11, to service provider 3, allow service provider 3 to bid on providing the desired set of services selected by client 2 using the bid form, and associate the bid with the unique record in request for proposal table 44.

Analysis software 66 is typically configured to compare bid data from one service provider 3 against bid data from each other service provider 3 for a specific, selected request for proposal record in request for proposal table 44 and generate a ranking for each such service provider 3 with respect to the specific request for proposal data associated with client 2.

Response software 68 is typically configured to present a rank ordered set of each such service provider 3 without allowing any service provider 3 to see any actual bid data from another service provider 3 while, at the same time, allowing client 2 to see actual bid data from each such service provider 3.

In the operation of exemplary embodiments, a bid from a provider of services, i.e. service provider 3 (FIG. 1), may be obtained by creating client RFP document 100 (FIG. 2) which is as described above. This can be via web portal 10 (FIG. 1) or any similar means, such as but not limited to paper forms or computer scannable forms or the like or a combination thereof. Such a bid will be for supplying one or more of the requirements and requests reflected in client RFP document 100 (FIG. 2), i.e. a conforming bid.

Responses from service providers 3 to requirements and requests reflected in client RFP document 100 (FIG. 2) are usually accomplished using web portal 10 (FIG. 1) by having each invited service provider 3 (FIG. 1) supply an answer to each required portion in client RFP document 100 when prompted to do so by a form on web portal 10. In some embodiments, service provider 3 may be allowed to import a client RFP document service provider rate response using a predefined import template corresponding to a specific service type. Additionally, an Administrative User (described below) may import a current cost for a specific service type by using a predefined rate import template corresponding to a specific service type.

Web portal 10 (FIG. 1) is usually configured to selectively allow access to client RFP document 100 (FIG. 2) to clients 2 (FIG. 1), who created a client RFP document 100, and service providers 3 (FIG. 1) who have been granted such access.

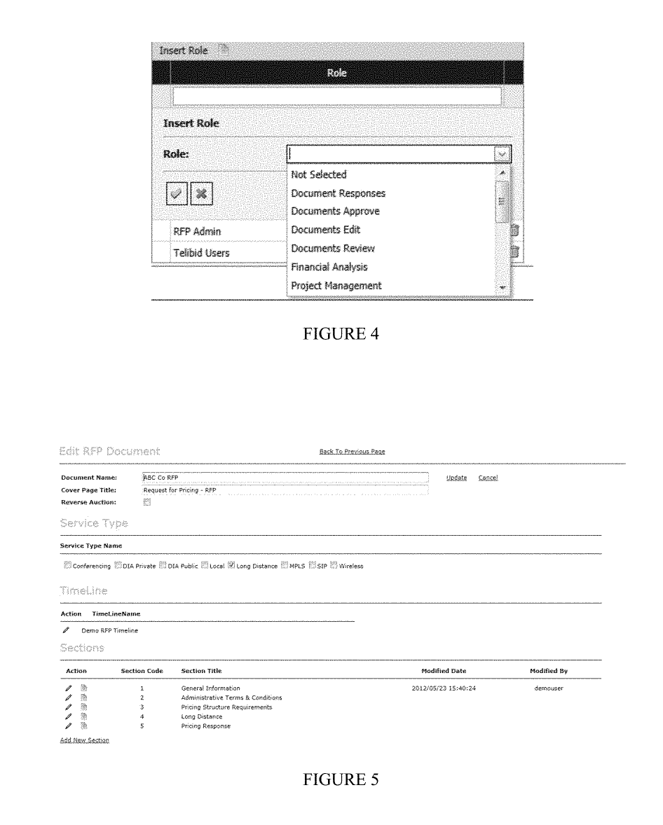

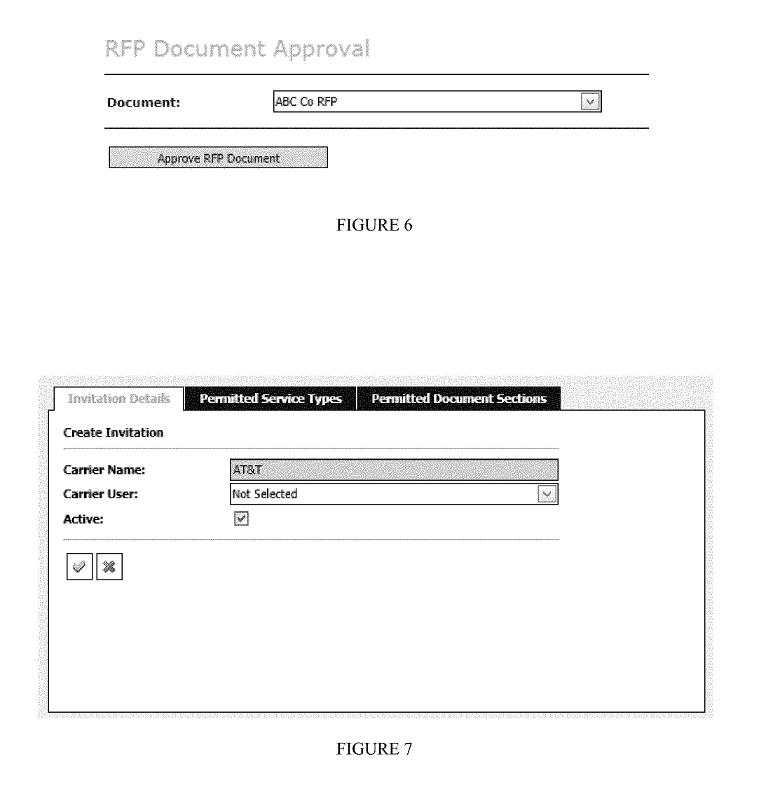

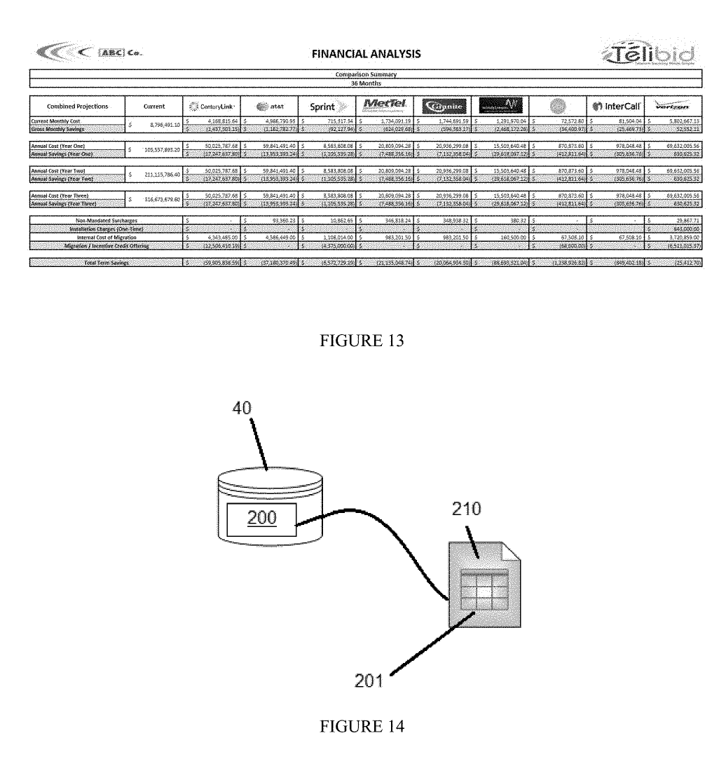

By way of example and not limitation, each user of web portal 10 is typically categorized such as an Administrative User, a Client User for client 2 (FIG. 1), a Service Provider User for service providers 3 (FIG. 1), or the like. Web portal 10 (FIG. 1) further typically comprises a set of user interface displays, generally described below, which implement and provide a user interface configured to provide a plurality of options to each user of web portal 10. Typically, the user interface selectively guides a user of web portal 10 in the steps needed to complete their required input into the RFP process. By way of further example and not limitation, web portal 10 may comprise or otherwise make various forms available such as browser-enabled or other Internet available forms, as illustrated in FIGS. 3-14. As illustrated in FIGS. 3-14, either an Administrative User or Client User with appropriate permissions can setup a Client User account (FIG. 3) and assign one or more roles/permissions to such a user (FIG. 4). Client Users can create and/or edit client RFP documents 100 (FIG. 2) and approve such client RFP documents 100 via one or more forms (FIGS. 5 and 6). Once submitted, Service Provider Users may be invited to view and respond to client RFP documents 100 via a form (FIG. 7). Client User and others may see a list of those Service Provider Users who have been invited, along with status information on their bidding, if any (FIG. 8). Client Users and/or Service Provider Users may retrieve (FIG. 9) client RFP documents 100 and modify various aspects of their response (e.g., FIG. 10). As illustrated in FIG. 10, Client Users can add descriptive or disclaiming qualifiers to portions of client RFP documents 100 (FIG. 11). Service Provider Users can use one or more forms (e.g., FIG. 12) to qualify and/or create a response to client RFP documents 100. Once bidding ceases, as described below, a weighted report (FIG. 13) may be generated and presented to client 2 such as on demand via web portal 10.

Client RFP document 100 (FIG. 2) may further comprise a client RFP document profile and a current spend by service types outline. In these embodiments, client RFP document 100 creation may further comprise adding a service type that is within a scope of client RFP document 100 to a client RFP document profile; creating a link between client RFP document 100 and a current spend by service types outline in client RFP document 100; and creating a link to client RFP document 100 and an entry placed on all service provider profiles that are invited to bid on that service type for a specific RFP embodied within client RFP document 100. For client RFP documents 100 that include document sections 107 (FIG. 2) and document subsections 108 (FIG. 2), these document sections 107 and document subsections 108 may be numbered and categorized each document section 107. For a plurality of invited service providers 3 (FIG. 1), a response from a first invited service provider 3 may be compared to each other response from each other invited service provider 3 using the numbered and categorized document section 107 and document subsection 108 for a document section 107 or document subsection 108 which requires a response.

Typically, each client 2 (FIG. 1) has an assigned account which comprises a username, password, and a profile. (See, e.g., FIGS. 3 and 4) Client 2 may be allowed access to a specific client profile and client RFP document 100 (FIG. 2) associated with the specific client profile.

Each client 2 typically has the option to use their own document, which is in a predetermined format such as a Microsoft® Word® format, or use a customer tailored document that caters to their specific needs. Once the content of RFP document 100 (FIG. 2) is processed and analyzed as described herein, a copy of RFP document 100 (FIG. 2), in Word® format, is imported into system 1. The process of loading a document into system 1 is a technological breakthrough in document handling.

Once loaded, system 1 parses RFP document 100 (FIG. 2), extracts various information such a section number, section name, subsection number, and subsection name, and inserts the extracted information into a predetermined data structure such as for ease of maintenance and segregating individual section/subsection responses from each service provider 3. It is understood that there may be none or a plurality of each of these various information members.

An option may be provided to require a written response and/or compliance to the context of a section/subsection from service provider 3 to whom access will be granted. Additionally, an option may exist to flag a specific item of the extracted information to require a positive compliance response to that specific item. As used herein, items requiring a positive compliance response are referred to as “deal-breakers.” The absence of a positive compliance response to a deal-breaker item may automatically disqualify service provider 3 from further consideration.

Upon document import, a response placeholder corresponding to a response from service provider 3 is typically created for each section/subsection in the document to which service provider 3 has access. If the section/subsection requires an answer or contains a compliance question, each response is captured and stored.

With each open request, system 1 analyzes the responses provided by each such service provider 3 and provides completion statistics to client 2. These completion statistics can allow a real-time view into the request process. Without system 1, client 2 would not be able to view the completion in real-time and would need to wait for service provider 3 to submit a completed response document. System 1 also permits real-time comparison of responses from all service providers 3 to each section/subsection. This permits client 2 to compare responses from service providers 3 in real-time on a response item level. This eliminates a manual collation of all provider responses.

Typically, service providers 3, upon login to system 1, are required to respond to deal-breaker questions first. Only after they have responded positively to the deal-breaker questions are they permitted to continue. This process gives each such service provider 3 an immediate alert that they are no longer considered and gives them the option to change their response without any intervention from client 2 and/or system 1. Additionally, service provider 3 receives instant feedback on their response and eliminates delay in requesting an updated response after the close of the request.

The capturing of responses from service providers 3 is done for each section/subsection on a section/subsection by section/subsection basis. Service provider 3 sees information related to a section/subsection and any written response and compliance requirements for that section/subsection. This permits service provider 3 to have the appropriate personnel in appropriate departments respond to sections/subsections that apply to the scope of their department. This expedites the response time from service providers 3 by permitting input from multiple departments substantially simultaneously.

Similar to a document section, a document subsection can have the same response requirements. They are also typically created during importing of RFP document 100 (FIG. 2). For example, document section 1 may have four subsections (1.1, 1.2, 1.3 and 1.4) which would result in the creation of four document subsections for the parent document section. All responses for document subsections are separate and distinct from the parent. They can also include compliance questions, including deal-breakers. Each response is typically logged separately from service provider 3. If any deal-breaker compliance responses are present in either the document section or subsection, all must be responded to with a positive response before service provider 3 can continue on to other questions. Any negative response to a deal-breaker question typically automatically disqualifies service provider 3 and removes further access to the request document and rates for that service provider 3 with respect to responses to RFP document 100.

Client 2 typically provides system 1 with a list of service items that are included in the request. These service items are typically detailed by service type. In addition, client 2 typically indicates which term length is to be applied to the request. Client 2 has the option of applying multiple term length requests simultaneously. The services items may be provided by client 2 in Excel® format, or client 2 can choose to have system 1 to conduct data mining from invoices of client 2. Once the Excel® file is built of the available service items, they are imported into system 1.

Referring additionally to FIG. 14, the importing of service items into system 1 is a further technological breakthrough. To start the process of importing inventory for a given service, inventory template 200 is exported from system 1, typically to service template 201 in spreadsheet file 210 which is formatted to comprise a predetermined set of columns for the service items client 2 wishes to import. All service templates 201 generally contain tabs for each segment of the desired service or services, along with explicit instructions of how to populate inventory template 200 to create service template 201. Once service template 201 is exported, service items to be imported are populated and then spreadsheet file 201 is uploaded to system 1. System 1 will then process spreadsheet file 201, generally comprising reading it, validating the items for completeness and accuracy, and locating each such item to be updated in database 40. If any errors are found, system 1 creates a report, typically an error spreadsheet, indicating which content in spreadsheet file 210 resulted in error and the reason for the error.

Without importing/exporting within system 1, all document responses and inventory service items would need to be done manually through data entry. Thus, system 1's data validation that occurs for each document response and inventory service item is unique to all aspects of the request/response of a sourcing engagement. Segmenting document sections and creating placeholders for the computation of percentage of completion as well as the ability to report on no responses is also unique.

System 1 can automatically create placeholders for provider responses for each service item and term length combination, making it easy to collect and analyze each term length separately. Client 2 may request rates for multiple term lengths in the same request. Terms lengths are typically for 12, 24 and/or 36 months.

All service inventory items represent the current services client 2 currently has installed. As each new service offer arises, system 1 may be updated to handle the service template for new services. Sample data structures for Long Distance service:

Additionally, service provider 3 (FIG. 1) may be allowed access to a specific service provider profile and to only those client RFP documents 100 for which they have an active invitation. The service provider active invitation usually comprises a set of permissions which selectively allow or disallow access to specific sections of client RFP document 100 to which a specific service provider 3 may respond as well as a definition of which service types on which they may place a bid.

The granting and denying of provider access to specific document sections and inventory service elements is unique to system 1 and the sourcing industry. When service provider 3 (FIG. 1) accesses system 1, they are presented with a list of deal-breaker questions initially. Service provider 3 must respond with a positive compliance to these questions first. If they do not respond positively they are typically disqualified immediately and their access to the request is automatically revoked. If service provider 3 is permitted to continue, the remaining responses to the request are opened for access, providing access has been granted. They are also permitted to export the inventory service items in which they are permitted to respond.

Without this feature, client 2 would need to wait for the provider's response, normally towards the closing date of the request, only to discover service provider 3 will not comply with the initial requirements of the response. This wastes time and money for client 2, system 1 and service provider 3.

Once obtained, client RFP document 100 (FIG. 2) may be stored in data store 30 (FIG. 1), which can be accessed by using web portal 10 (FIG. 1). Receipt and storage of client RFP document 100 may then trigger, such as by bid software 60 (FIG. 1), inviting one or more service providers 3 (FIG. 1) to be invited to respond to a stored client RFP document 100 by submitting a bid. To do so, each invited bidding service provider 3 may be allowed to access a stored client RFP document 100, typically during all of the duration of RFP timeline 109 (FIG. 2) embodied within client RFP document 100, and further allowed to respond to a stored client RFP document 100 by submitting an indication of the specific requirements with which service provider 3 will comply. Typically, for each specific requirement with which service provider 3 will comply, service provide 3 supplies an indication of how they will comply with each specific requirement; a textual response, if needed, such as to further clarify their response; and the actual bid for services from service provide 3 which represents the financial aspect of services they wish to provide to client 2.

Upon completion of the deal-breaker compliance response requirements, service provider 3 can then access the inventory service items to which they have been granted access. Service providers 3 first typically export service item template 201 (FIG. 14) for a given service. This will list out the common data for a given service item response and typically include client name, document name, location, reference number, and service specific response columns. Service provider 3 then can enter their response into exported spreadsheet 210 (FIG. 14). Upon completion of all responses in spreadsheet 210, service provider 3 can then import spreadsheet 210 back into system 1. System 1 will verify the information provided and stow all responses into appropriate placeholders which have been created. Each placeholder, whether they are section, compliance, or inventory service item responses, counts as a total number of responses required. For example, service provider 3 may need to respond to 10 sections, 20 sub-sections, and 400 inventory service items, for a total of 450 responses. The completion statistics is computed by setting the percentage of completion to (total provided/total required). Client 2 can view completion statistics real time. Service provider 3 typically then receives an email with their completion statistics starting seven days prior to the close of a request. The email is sent daily until close or until service provider 3 has completed 100% of the response requirements.

This feature manages the progress of service provider 3 and alerts both client 2 and service provider 3 of the progress of such service providers 3. This actually tends to increase response time from service provider 3 since service provider 3 does not want to look bad in the eyes of client 2.

In order to provide client 2 a true cost from a given provider, the option to collect non-mandated surcharges from service provider 3 is typically set on the request document, e.g. via a Boolean flag or semaphore or the like. Service provider 3 must then import their non-mandated surcharges (NMS) for the surcharges that are configured on the inventory service item. The provider's NMS charges are represented as a percentage and applied to specific columns in the response from service provider 3 to compute NMS charges by provider/service. This feature prevents hidden costs from service provider 3 if that service provider is selected. It also gives power to client 2 to have service provider 3 remove undisclosed additional costs during contract negotiation as well as from billing after services are installed.

The computation of non-mandated surcharges typically uses dynamic structure query language (SQL) in the database code and, accordingly table and column names are typically included for such use. The dynamic SQL code builds the query to execute to compute NMS based on the configuration of the tables and columns to which the NMS charge applies.

NMS charges are also typically included in the financial analysis report for a true net-net cost assessment. This feature provides a true net-net amount on the financial analysis report for client 2 to make a more informed decision on which service provider 3 to award a contact at the end of the final round on a specific request. For example, not all service providers 3 charge the same tax amount nor do they charge the same NMS charges. This feature gives a clear picture to client 2 and holds service provider 3 accountable for not disclosing hidden charges and taxes.

At a first predetermined time, bid software 60 (FIG. 1) obtains all completed responses and all rate elements from bidding service provider 3 (FIG. 1). At a second predetermined time, bid software 60 generates a comparative financial analysis showing a sorted list of responses. This analysis, typically by analysis software 66 (not shown in the figures), indicates savings over current costs 105 on a service provider by service provider basis and indicates savings over current costs 105 on a service type by service type basis, as illustrated in FIG. 13.

Generating the comparative financial analysis comprises generating a true monthly cost comparison for each service provider 3 (FIG. 1) that bids on a specific service type. In a first preferred embodiment for telecommunications services, a sum of the product of rate units/quantities multiplied by the rate per unit/quantity for all rate elements per service type is created for current costs and corresponding rate responses from each service provider 3 bidding on that service type. For telecommunication service providers, migration credits are subtracted and internal migration costs are added together. The internal migration costs are extrapolated out over a term of the commitment.

Client RFP document 100 (FIG. 2), as originally created, may be coupled with responses from service provider 3 (FIG. 1) to client RFP document 100 linked to each document section 107 (FIG. 2) and document subsection 108 (FIG. 2) that required a response and to which service provider 3 was invited to respond.

The financial analysis may further comprise comparing the total to be spent to the total bid from service provider 3 (FIG. 1) for each service type and service provider after all service provider responses have been received.##

At a third predetermined time, bid software 60 (FIG. 1), e.g. response software 68 (not shown in the figures) and/or analysis software 66 (not shown in the figures), may generate a weighted report which comprises a display of bids having a best compliance with client RFP document 100 (FIG. 1) such as in a top down order based on the comparative financial analysis. This generated weighted report (FIG. 12) may then be presented to client 2 (FIG. 1) such as on demand via web portal 10 (FIG. 1).

In certain embodiments, an auction process may take place including selectively enabling or disabling a reverse auction by using an option on a client RFP document level during the duration of RFP timeline 109 (FIG. 2). The RFP timeline 109 may be embodied within client RFP document 100 (FIG. 2). For enabled reverse auctions, automatic updates of rankings of bids from an invited service provider 3 (FIG. 1) may be displayed, such as when service provider 3 submits a bid, including a display of rankings of each bid from each invited service provider 3 against each bid from each other invited service provider 3 and of each bid from each invited service provider 3 by their current rank in the bidding process.

An invited service provider 3 (FIG. 1) may further be allowed to run a document response report and/or a rate response report in real time on demand during the duration of an RFP timeline embodied within client RFP document 100 (FIG. 2). Client 2 (FIG. 1) may also be allowed to run a document response report and/or a rate response report in real time on demand at any time as their access permits.

In an alternative method, obtaining a bid from service provider 3 (FIG. 1) for providing a set of desired services to client 2 (FIG. 1) comprises obtaining a set of desired services from client 2, such as third-party telecom services; providing a first browser-based form that displays the set of desired services to a predetermined number of service providers 3 such as third-party telecom service providers; and obtaining a bid from a plurality of these service providers 3 to provide one or more of the set of desired services.

Once obtained, the bids obtained from each of the service providers 3 (FIG. 1) may be analyzed to generate a ranking for each such obtained set of bids, the ranking based on a predetermined set of ranking criteria. The analysis is typically performed by analysis software 68 (not shown in the figures) resident in computer 20 (FIG. 1) operatively in communication with the first browser-based form and may be triggered automatically by entry of one of the bids from one of service providers 3.

A first ranked listing display of the ranked bids may be generated and made available via a second browser-based form viewable by service providers 3 (FIG. 1), where the second browser-based form displays the ranking but not the actual bid data from service providers 3. A second ranked listing display may also be generated based on a predetermined set of ranking criteria and the actual bid data from the service providers 3. Client 2 (FIG. 1) may be allowed to view the second ranked listing display such as via a third browser-based form viewable by client 2, where the third browser-based form displays the ranking and the actual bid data from the providers of services.

In third embodiment, a bid from service provider 3 (FIG. 1) to provide a set of services to client 2 (FIG. 1) comprises obtaining login information from client 2, who is a consumer of services, and validating the login information. Upon validation, a predetermined portion of a browser-based form, viewable by client 2, is populated with a set of predefined service templates associated with client, e.g. by bid software 60 (FIG. 1). A set of allowable service types for client is displayed, such as via a first browser-based form and a set of desired service types obtained from client from the set of allowable service types. This set of desired service types may be associated with a request for services and the request for services associated with client 2 such as via client RFP document 100 (FIG. 2) which is stored in data store 30 (FIG. 1).

A predetermined set of service providers 3 (FIG. 1) may then be invited to bid on providing those service providers 3 with access to the set of desired service types, e.g. via access to client RFP document 100 (FIG. 2), and allowing each of the invited service providers 3 to submit a bid to provide the desired service types associated with the request. This provision may be by using a second browser-based form.

Upon receipt of each such bid, analysis software 68 (not shown in the figures) may be used to analyze the obtained set of bids and generate a ranking for each such obtained set of bids, where the ranking is based on a predetermined set of ranking criteria. The analysis may be performed either on demand, periodically, automatically, by being triggered by receipt of a change in a bid from service provider 3 (FIG. 1), or the like, or a combination thereof

A ranked listing display of the ranked bids may be made available to client 2 (FIG. 1) via, e.g., a fourth browser-based form viewable by client 2 and invited service providers 3 (FIG. 1). Ranking is typically based on the total rates.

Invited service providers 3 (FIG. 1) may only see the ranking but not the actual bid data from the other service providers 3. However, client 2 (FIG. 1) may be allowed to view the ranking, such as via another browser-based form only viewable by client 2, based on a predetermined set of ranking criteria, and see the actual bid data from the service providers 3, as illustrated in FIG. 13. Client 2 may also be allowed to filter the bids by selecting one of the desired service types and, upon selection of the desired service type, populating a portion of the browser-based form with preview rate responses.

Where template 200 (FIG. 14) comprises a request for proposal, template 200 may be populated with information for a plurality of service types and, upon selection of template 200 by client 2 (FIG. 1), service providers 3 (FIG. 1) for each requested service type may be listed or otherwise displayed.

Financial analysis reports, which are exclusive to system 1, may be generated and are very specific to how system 1 applies responses from service providers 3, NMS charges, and taxes. The algorithms used produce true net-net comparisons. All reports are generally dynamic in nature, providing comparison columns for each service provider 3 responding to given request. For example, one request may have three service providers 3 responding, and another request may have ten service providers 3 responding. The report will automatically adjust the columns on the report to accommodate the number of responding service providers 3. In addition to the financial analysis report by inventory service, system 1 may generate an all services report which blends all individual service reports into a combined financial analysis report for an overall view into the request result.

In any of these methods, service providers 3 may be allowed to adjust their bids during a predetermined period of time, e.g. an RFP timeline 109 (FIG. 2) embodied within client RFP document 100 (FIG. 2). Further, client 2 (FIG. 1) may be allowed to select one of the ranked bids, either at the conclusion of the process or at any time and, if client 2 does so, the service provider 3 that submitted that selected bid may be notified of the selection. In some embodiments, an advance agreement may be obtained from service provider 3 (FIG. 1), stating that making the bid constitutes a legally binding offer from service provider 3 and a corresponding advance agreement obtained from client 2 that selecting the bid by client 2 constitutes a legally binding acceptance of that offer. Optionally, service providers 3 who are not selected may be notified that they were not selected such as by electronic mail.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A method of obtaining and displaying a conforming bid from a service provider to provide a set of services to a consumer on a graphical user interface, comprising:
a. obtaining an electronic document from a consumer;
b. parsing the electronic document to extract information related to a set of desired services from the consumer, each desired service of the set of desired services comprising a service descriptor, a predetermined set of service characteristics, and a positive compliance response required flag;
c. importing the parsed electronic document into a database;
d. generating a request for bid, the request for bid describing each desired service of the set of desired services;
e. obtaining a set of service providers capable of bidding on the set of desired services;
f. notifying the set of service providers capable of bidding of the request for bid;
g. obtaining a set of actual bids from at least one of the service providers, each actual bid of the set of actual bids responsive to the request for bid;
h. validating each actual bid against a predetermined set of validation data, the validation data related to the service provider who submitted the actual bid, validating further comprising invalidating a bid that fails to comply to each required positive compliance response in the set of desired services;
i. notifying a service provider whose bid is not validated of the lack of validation;
j. for each validated submitted bid,
i. reducing data in the validated submitted bid related to the request for bid into commonly denominated data expressed in a singular set of units of measure; and
ii. adjusting the commonly denominated data using a predetermined set of historical data;
k. using the adjusted commonly denominated data to generate a ranking for each validated submitted bid in real time, the ranking based on a predetermined set of ranking criteria;
l. generating a financial analysis report viewable by the consumer who generated the request for bid in real time, the financial analysis report based on the adjusted commonly denominated data and reflecting the generated rankings;
m. dynamically displaying the financial analysis report in real-time to allow comparison of responses from all service providers who provided a validated bid to each the set of desired services on a response item level on a true net-net basis in a location of a bid display region, each service provider's response displayed in a separate location in the bid display region corresponding to a net-net analysis associated with at the response from that service provider; and
n. in response to a selection of a particular location of the displayed financial analysis report by a single action of a user input device, allowing the consumer to select a bid.

2. The method of obtaining a conforming bid from a service provider to provide a set of services to a consumer of claim 1, wherein each service provider is required to respond to required positive compliance responses first and only permitted to continue with the bidding process if they responded positively to each of the required positive compliance responses.

3. The method of obtaining a conforming bid from a service provider to provide a set of services to a consumer of claim 2, further comprising, for service providers who not respond positively for to each of the required positive compliance responses:
a. notifying that service provider that the service provider is disqualified immediately; and
b. automatically revoking that service provider's access to the request.

4. The method of obtaining a conforming bid from a service provider to provide a set of services to a consumer of claim 1, wherein parsing further comprises:
a. exporting an inventory template to a service template in a spreadsheet file formatted to comprise a predetermined set of columns for the service items the consumer wishes to import, the service template comprising a set of tabs for each segment of the service, along with explicit instructions of how to populate the service template;
b. providing the exported service template to the service provider;
c. allowing the service provider to populate the exported service template with service items to be imported into the exported service template;
d. uploading the spreadsheet file to the system;
e. processing the uploaded spreadsheet file, the processing comprising reading the uploaded spreadsheet file, validating the items for completeness and accuracy, and locating each such item to be updated in a database; and
f. if any errors are found, creating a report indicating which content in the spreadsheet file resulted in error and the reason for the error

5. The method of obtaining a conforming bid from a service provider to provide a set of services to a consumer of claim 1, wherein parsing is accomplished on a section/subsection by section/subsection basis, the method further comprising:
a. allowing the bidding service provider to see information related to a section/subsection and any written response and compliance requirements for that section/subsection; and
b. allowing the bidding service provider to have appropriate personnel in appropriate departments respond to sections/subsections that apply to the scope of their department.

6. The method of obtaining a conforming bid from a service provider to provide a set of services to a consumer of claim 1, wherein each desired service of the set of desired services further comprises a requirement flag indicating whether or not a written response is required to be supplied.

7. The method of claim 1, wherein the request for bid further comprises a predetermined period of time during which the service providers may submit an actual bid.

8. The method of obtaining a conforming bid from a service provider to provide a set of services to a consumer of claim 1, further comprising allowing the consumer to select one of the validated bids from the providers of services.

9. The method of claim 8, wherein:
a. a service provider pre-agrees that the service provider's making the bid constitutes a legally binding offer; and
b. the consumer pre-agrees that selecting the bid constitutes a legally binding acceptance of that offer pending contract execution.

10. The method of obtaining a conforming bid from a service provider to provide a set of services to a consumer of claim 1, wherein validating each actual bid against a predetermined set of validation data further comprises:
a. comparing a predetermined set of the data related to the set of desired services in the request for bid present in the actual bid against a set of validation data;
b. generating a variance result for each such datum; and
c. rejecting each such datum in the actual bid whose variance does not meet a predetermined variance criterion.

11. The method of obtaining a conforming bid from a service provider to provide a set of services to a consumer of claim 1, wherein the predetermined set of historical data further comprises objective data and subjective data.

12. The method of obtaining a conforming bid from a service provider to provide a set of services to a consumer of claim 1, wherein the providers of services comprise providers of telecommunication-related services.

13. The method of obtaining a conforming bid from a service provider to provide a set of services to a consumer of claim 1, further comprising:
a. setting an option to collect a set of non-mandated surcharges from the service provider;
b. including a table name and column names in the exported service template;
c. requiring the service provider to import their non-mandated surcharges for the surcharges that are configured on the inventory service item;
d. using dynamic SQL code resident in a database to build a query which, when executed, computes non-mandated surcharges based on the configuration of the tables and columns to which the non-mandated surcharges charge applies; and
e. applying each such computed non-mandated service charge to specific columns in the provider's response to compute non-mandated service charges by provider/service to generate a financial analysis report for a true net-net cost assessment.

14. A system for providing a bid from a service provider to provide a service to a consumer, comprising:
a. a data store operatively accessible to a user via the Internet;
b. a database disposed on the data store, the database comprising:
i. a set of inventory templates;
ii. a service provider table populated with service provider data associated with each service provider a set of service providers;
iii. a request for bid table populated with request for bid data associated with each consumer of a set of consumers; and
iv. a bid table populated with service provider actual bid data associated with each service provider and data in the request for bid table;
c. a computer operatively in communication with the Internet and the data store;
d. bid generation software resident in the computer and operatively accessible via the Internet, the bid generation software operatively in communication with the database, the bid generation software comprising:
i. template software operative to present a consumer with a set of predefined, selectable service templates via a consumer viewable medium, obtain a consumer selected desired set of services from a set of allowable service types for the consumer, and associate the selected desired set of services with a unique request for bid associated with the consumer;
ii. bid software operative to generate a bid services set from the selected desired service types, notify a set of service providers of the generated bid service set, and provide notified set of service providers with the generated bid service sets;
iii. bid acceptance software operative to accept actual bid data from the notified service providers, validate the accepted bid data, and notify a service providers of the notified service providers of that service provider's actual data is invalid;
iv. analysis software operative to reduce data in each validated submitted bid related to the request for bid into commonly denominated data expressed in a singular set of units of measure, adjust the commonly denominated data using a predetermined set of historical data, and generate a ranking for each validated submitted bid using the adjusted commonly denominated data, the ranking based on a predetermined set of ranking criteria; and
v. report software operative to present analyzed data comprising the ranking for each service provider who submitted a bid on a consumer viewable medium.
